(19) United States
(12) Patent Application Publication
(10) Pub. No.: US 2015/0063408 A1
(43) Pub. Date: Mar. 5, 2015

(54) GASEOUS CONCENTRATION MEASUREMENT APPARATUS

(71) Applicant: DECAGON DEVICES, INC., Pullman, WA (US)

(72) Inventors: Ronnie Ken Byers, Pullman, WA (US); Gaylon S. Campbell, Pullman, WA (US)

(73) Assignee: DECAGON DEVICES, INC., Pullman, WA (US)

(21) Appl. No.: 14/018,333

(22) Filed: Sep. 4, 2013

(51) Int. Cl. G01N 21/39; G01J 5/00

(52) U.S. Cl. CPC G01N 21/39; G01J 5/0014
USPC 374/45; 250/343; 250/428; 374/121

(57) ABSTRACT

An apparatus is configured to measure various properties of sample in a sample chamber such as, for example, water activity. The apparatus includes a tunable diode laser that emits laser radiation into the sealed chamber without passing through the air outside the sample chamber or a wall of the sample chamber. The laser radiation only passes through the gaseous mixture in the sample chamber. A temperature sensor such as an infrared thermometer is positioned to measure the temperature of a sample in the sample chamber. The apparatus may be configured to include a plurality of sample containers each of which includes a sealed sample chamber. The sample containers may be automatically fed through the apparatus and analyzed with the tunable diode laser without any operator input or interaction.

### INCORPORATION OF RELATED PATENT APPLICATIONS

The entire contents of the following documents are incorporated by reference herein: U.S. Pat. No. 6,639,678, titled “Apparatus and Method for Nondestructive Monitoring of Gases in Sealed Containers,” issued on 28 Oct. 2003. In the event of a conflict, the subject matter explicitly recited or shown herein controls over any subject matter incorporated by reference. For example, the incorporated subject matter should not be used to limit or narrow the scope of the explicitly recited or depicted subject matter.

### BACKGROUND

Tunable diode laser absorption spectroscopy (TDLAS) is a technique that can be used to measure the concentration of a gas species such as water vapor, methane, and more, in a gaseous mixture. As the name suggests, the technique relies on a tunable diode laser (TDL) and laser absorption spectrometry (LAS) to perform the measurement.

One of the advantages of TDLAS over other techniques for concentration measurement is its ability to measure very low concentrations, on the order of parts per billion (ppb). Another advantage is that TDLAS is capable of distinguishing between species that are relatively closely related such as a mixture of water and ethanol. Also, it is capable of measuring other parameters of the gas under investigation such as temperature, pressure, velocity and mass flux.

These advantages stem largely from the ability of the TDL to be finely tuned in respect to its frequency to the specific absorption band of the target species. The energy absorbed at this tuned frequency is proportional to the concentration of the target species. For example, the TDL can be tuned to measure the water vapor concentration in a mixture of water vapor and ethanol vapor without measurement interference from the ethanol when other measurement devices such as broad-band optical sensors cannot distinguish between the two vapors. One application for which TDLAS is particularly well suited is measuring water activity of samples containing interfering volatiles such as the water/ethanol mixture mentioned. This is a very challenging problem in the food industry as well as many others.

In one application, TDLAS is used to measure the water activity of a sample. The sample is enclosed in a transparent container and placed in a temperature controlled device that includes a tunable diode laser and a detector. The temperature is held constant to allow the water vapor in the headspace of the container to equilibrate with the sample.

The laser radiation source and the corresponding detector are positioned on opposite sides of the sealed container. The laser radiation passes through the outside air, the container wall, the headspace of the container, the opposite container wall, and the outside air, until it finally reaches the detector. The outside air and the container wall introduce measurement noise and errors that must be accounted for to get an accurate reading.

The outside air has a different mixture of gases than that in the headspace of the sealed container. One way to minimize errors caused by the outside air is to purge the area around the container with dry nitrogen while the measurement is taken. This purging requires seals and enclosures. The purging gas also increases the measurement cost.

The optical characteristics of the container wall can also adversely affect the measurement. The optical characteristics can vary from one container to the next and can be influenced by foreign matter present on the exterior or interior surface such as dirt, smudges, and the like. The container material could also skew the measurement accuracy. There have been attempts to reduce this measurement error using complicated approaches such as spinning the containers during testing. Despite these attempts, the container wall still presents a significant source of measurement error.

Another problem associated with conventional water activity measurement devices stems from the way the temperature is measured. The water activity of the sample is assumed to be the vapor pressure in the head space, as measured by the TDL, divided by the saturation vapor pressure at the temperature of gases in the head space. This works when the temperature of the gases and the sample are the same. Unfortunately, they usually are not and even small differences can cause significant measurement errors. For example, a temperature difference of 0.1° C. between the sample and the gases in the head space can result in a water activity error of 0.006.

Conventional systems for measuring water activity and water content tend to be single input systems that require operator oversight. The operator typically must manually position each sample container in the device, take the measurement, record the measurement, and remove the sample container. Opportunities exist to improve this process.

Current practice of sample testing utilizes opening the container which allows the test sample to be subjected to environmental conditions. These conditions could alter the sample makeup as compared to the sample makeup of interest.

Elevated temperatures and humidity conditions can contaminate many humidity sensors and reduce sample reading accuracy. Therefore, a state of constant calibration is needed to maintain accuracy.

The TDL system should be less prone to sensor contamination compared to other methods. For example, certain gases such as ethylene glycol tends to skew chilled mirror accuracy as well as what was aforementioned regarding typical humidity sensors.

### SUMMARY

A number of representative embodiments are provided to illustrate various features, characteristics, and advantages of the disclosed subject matter. The embodiments are provided in the context of water activity measurement apparatus. It should be understood, however, that the concepts may be used in a variety of other settings, situations, and configurations such as other types of measurement devices. Also, the features, characteristics, advantages, etc., of one embodiment may be used alone or in various combinations and sub-combinations with one another.

A measurement apparatus includes a sample container and a tunable diode laser. The measurement apparatus may be used to measure any of a variety of parameters associated with a gaseous mixture such as the concentration of a gaseous species in the mixture, temperature of the gaseous mixture, pressure of the gaseous mixture, velocity of the gaseous mixture, and/or mass flux of the gaseous mixture.

In one embodiment, the measurement apparatus is a water activity measurement apparatus. In this embodiment, the measurement apparatus is configured to at least measure the concentration of water vapor in a gaseous mixture. This can be used to determine the water activity of a sample in the sample container.

The sample container includes a sample chamber that holds the sample under investigation. The sample can be any material but is typically a non-gaseous material such as a liquid, solid, powder, and so forth. The sample chamber is sealed from outside air to prevent the outside air from contaminating the gaseous mixture in the sample chamber and causing measurement errors.

The tunable diode laser includes a laser radiation source and a laser radiation detector. The laser radiation source emits laser radiation that passes through the gaseous mixture in the sample chamber and is received by the laser radiation detector. The sample chamber can be located in the sample container.

The sample container includes a sealing member that closes an opening into the sample chamber. The measurement apparatus moves the sealing member from over the opening to allow the tunable diode laser access to the sample chamber without allowing outside air to enter the sample chamber. The tunable diode laser can emit laser radiation into the sample chamber without having it pass through the wall of the sample container, with the chamber remaining sealed from the outside air.

The water activity measurement apparatus may include a temperature sensor that directly measures the temperature of the sample. This may provide a more accurate measurement of the water activity of the sample in comparison to methods that, for example, measure the temperature of the gaseous mixture and assume that the sample is the same temperature.

Any suitable temperature sensor can be used and it can be positioned at any suitable location in the water activity measurement apparatus. For example, the water activity measurement apparatus may include an infrared temperature sensor positioned inside and at the top of the sample chamber. The temperature sensor may be used to measure the temperature of the sample at the same time the tunable diode laser is measuring the concentration of water vapor.

The measurement apparatus may also be automated to allow multiple samples to be analyzed with little or no operator input. Sample containers may be added to a feeder, tested, and ejected without any operator input. The sample containers may include electronics that store, transmit, and/or receive information about the sample in the container. This information may be analyzed later by the operator.

The system can also have the ability to control the sample to a set temperature determined by an operator. It can also be capable of changing the temperature of the sample from one temperature to a more preferred one.

The Summary is provided to introduce a selection of concepts in a simplified form that are further described below in the Detailed Description. The Summary and the Background are not intended to identify key concepts or essential aspects of the disclosed subject matter, nor should they be used to constrict or limit the scope of the claims. For example, the scope of the claims should not be limited based on whether the recited subject matter includes any or all aspects noted in the Summary and/or addresses any of the issues noted in the Background.

### DRAWINGS

The embodiments are disclosed in association with the accompanying drawings in which:

FIG. 1 is a perspective view of one embodiment of a measurement apparatus.

FIG. 2 is a perspective view of one embodiment of a sample container.

FIGS. 3 and 4 are exploded perspective views of the sample container shown in FIG. 2.

FIG. 5 is a bottom perspective view of the top housing of the sample container shown in FIG. 2.

FIG. 6 is a cross-sectional perspective view of the sample container shown in FIG. 2.

FIG. 7 is a perspective view of the measurement apparatus shown in FIG. 1 with the sensor unit positioned over the sample container and in position to measure one or more parameters associated with the sample in the sample container.

FIG. 8 is a cross-sectional perspective view of the sensor assembly positioned over the sample container shown in FIG. 7.

FIG. 9 is a perspective view of a portion of the feeding assembly for the measurement apparatus shown in FIG. 1.

### DETAILED DESCRIPTION

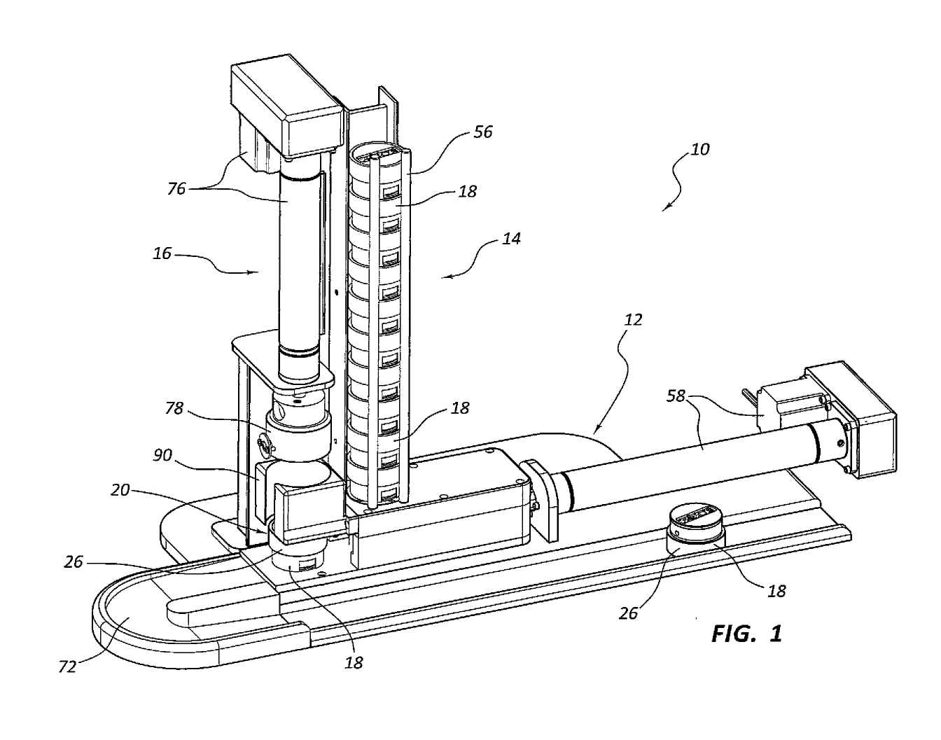

FIG. 1 shows a perspective view of one embodiment of a measurement apparatus 10 configured to measure the water activity of a sample. Those skilled in the art will appreciate that although the remainder of the description focuses on measuring water activity, the measurement apparatus 10 may be used to measure a variety of parameters such as the temperature, pressure, velocity, and/or mass flux of a gaseous mixture.

By way of background, the water activity is defined as:

$${a}_{w} = \frac{{p}_{a}}{{p}_{s}}$$

where a_{w} is the water activity, pₐ is the water vapor pressure, and pₛ is the saturation water vapor pressure at the temperature of the sample. The measurement apparatus 10 measures pₐ directly. The measurement apparatus 10 also measures the temperature of the sample. Once these parameters are known, it is a straightforward calculation to obtain the water activity since pₛ is determined by sample temperature.

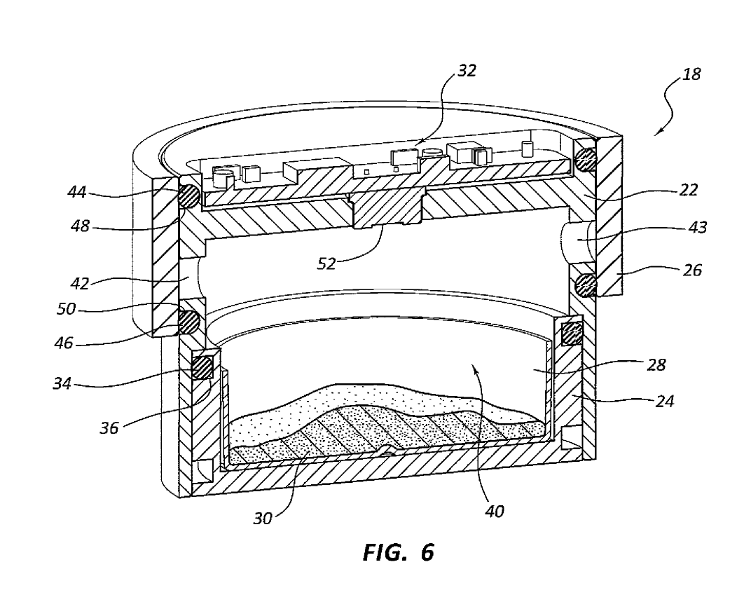

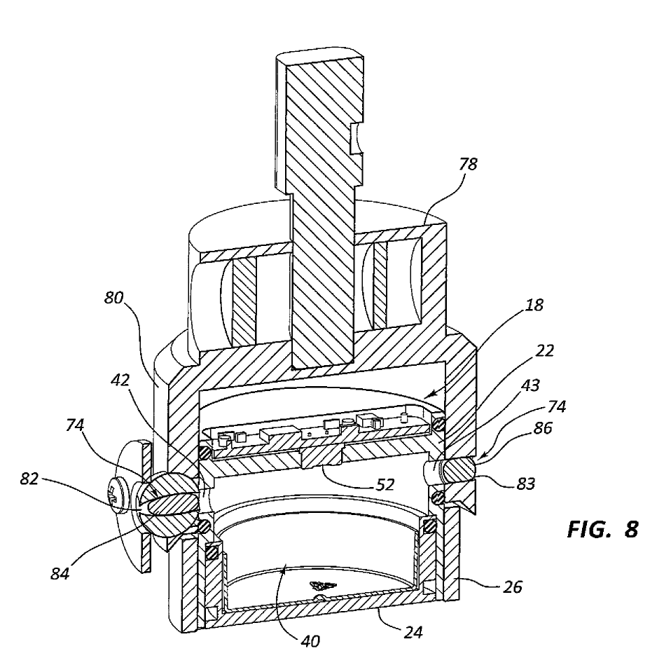

The measurement apparatus 10 includes a base 12, a feeding assembly 14, a sensor assembly 16 including a tunable diode laser 74 (FIG. 8), and a plurality of sample containers 18. The measurement apparatus 10 uses the tunable diode laser 74 to measure various parameters of the gaseous mixture inside the sample containers 18. Each sample container 18 includes a sample of material 30 (FIG. 6) ready to be analyzed. The measurement apparatus 10 feeds the sample containers 18 through a measurement station 20 where the water activity of each sample is measured.

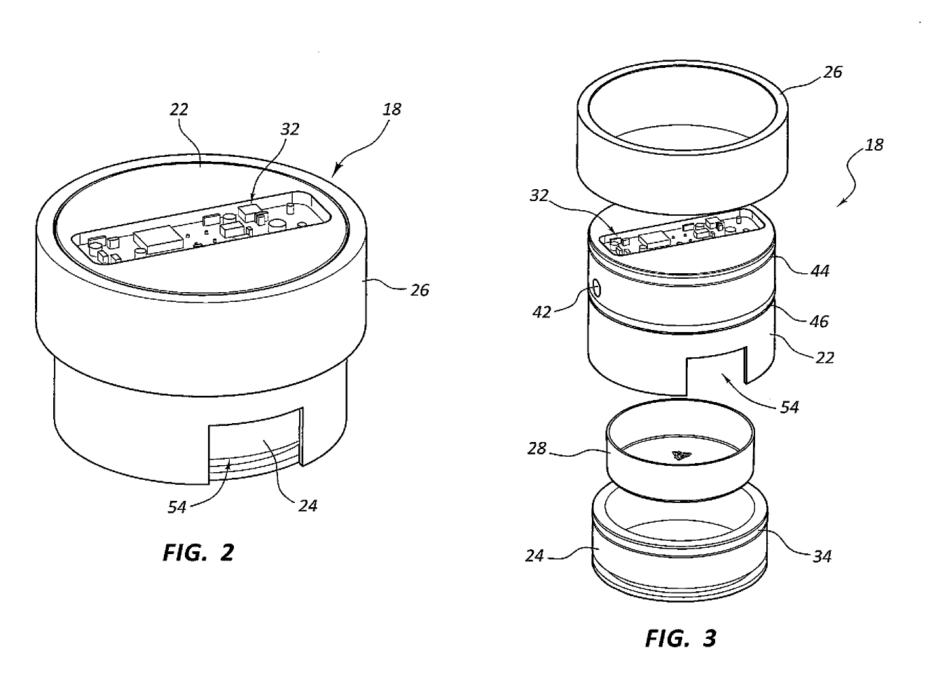

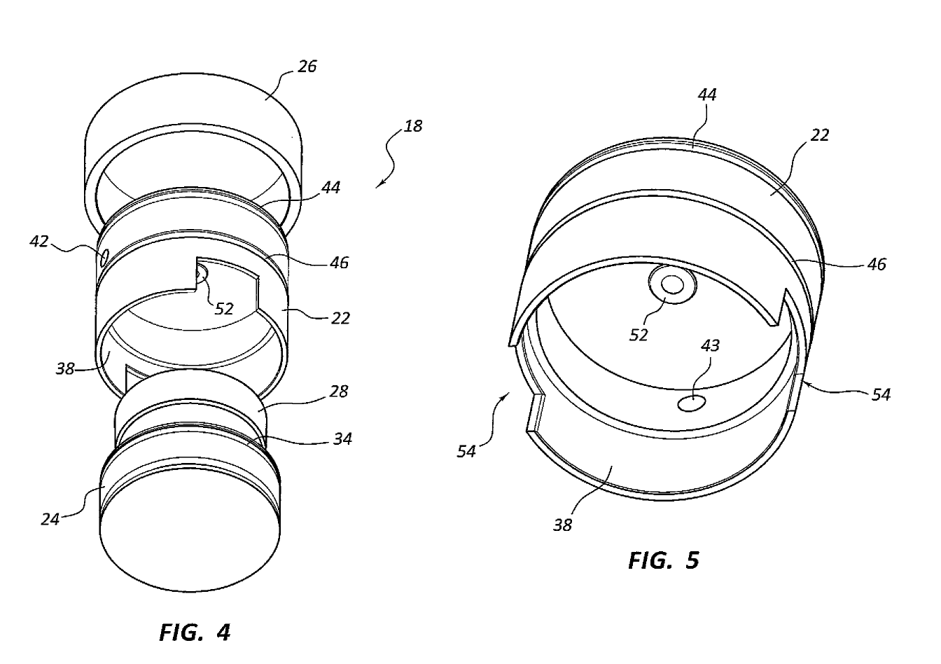

FIGS. 2-6 show the sample container 18 in greater detail. FIG. 2 shows the sample container 18 fully assembled and FIGS. 3-4 show exploded perspective views of the sample container 18 from the top and bottom, respectively. The sample container 18 includes a top housing 22, bottom housing 24, sealing member 26, sample cup 28, and electronics 32. The sample container 18 also includes a sample chamber 40 (FIG. 6) that is sealed from the outside air.

The top housing 22 is open on the bottom and the bottom housing 24 is open on the top. The top housing 22 is sized and shaped to receive the bottom housing 24 as shown in FIGS. 2-6. The bottom housing 24 includes a seal 34 that sits in a groove 36 around the outer circumference of the top of the bottom housing 24. When the top and bottom housings 22, 24 are coupled together, the seal 34 contacts an inner wall or surface 38 of the top housing 22 to seal the interior sample chamber 40 from the outside air.

It should be noted that for purposes of this disclosure, the term “coupled” means the joining of two members directly or indirectly to one another. Such joining may be stationary in nature or movable in nature. Such joining can be achieved with the two members or the two members and any additional intermediate members being integrally formed as a single unitary body with one another or with the two members or the two members and any additional intermediate member being attached to one another. Such joining can be permanent in nature or alternatively can be removable or releasable in nature.

The top housing 22 includes a notch or gap 54 that is used to align properly the sample container as it moves to the measuring station 20. The notch 54 also allows the operator to disassemble easily the sample container 18 for cleaning and sample actuation. A further description of the notch 54 and how it is used is provided below in connection with the description of the operation of the measurement apparatus 10.

Those skilled in the art will appreciate that the design of the housing of the sample container 18 may be modified in a number of ways. For example, the separate housings 22, 24 may be replaced by a single unitary housing with a fill hole. The fill hole may be closed to seal the sample chamber 40 from the outside air. Also, the shape of the housing may be something other than cylindrical, e.g., square, hexagonal, etc.

The top housing 22 includes a first opening 42 and a second opening 43 positioned opposite the first opening. The openings 42, 43 extend through the wall of the top housing 22 and into the sample chamber 40. The openings 42, 43 are provided to allow unimpeded access to the interior of the sample chamber 40 when the sample 30 is being analyzed.

The openings 42, 43 are positioned above the area occupied by the sample 30 to allow laser radiation to pass from one opening through the gaseous mixture in the head space, and on to the other opening. It should be appreciated that the openings 42, 43 may have any suitable configuration. For example, the top housing 22 may include a single opening or more than two openings. The tunable diode laser 74 could also be mounted permanently to the top housing 22.

The sealing member 26 is a rigid ring-shaped component that encircles the top portion of the top housing 22 and covers the openings 42, 43. The sealing member 26 seals the sample chamber 40 closing it from the outside air.

Those skilled in the art will appreciate that the sealing member 26 may have any of a number of configurations. For example, the sealing member 26 can have a different shape than a ring. Also, the sample container 18 can include multiple sealing members 26 where each sealing member 26 covers one of the respective openings 42, 43.

The top housing 22 includes an upper seal 44 and a lower seal 46 which are positioned in corresponding grooves 48, 50 in the outer surface of the top housing 22. The inner surface of the sealing member 26 contacts the seals 44, 46 to prevent the gaseous mixture inside the sample container 18 from escaping or mixing with the outside air.

The seals 34, 44, 46 may have any suitable configuration and be made of any suitable material. In one embodiment, the seals 34, 44, 46 are o-rings made of an elastomeric material such as buna. Those skilled in the art will appreciate that the housings 22, 24 and the sealing member 26 may be sealed using a variety of other sealing techniques.

The sealing member 26 moves between a closed position where the sealing member 26 covers the openings 42, 43 (FIGS. 2 and 6) and an open position where the sealing member 26 does not cover the openings 42, 43. (FIG. 1—the sealing container that has already passed through the measurement station 20). The sealing member 26 does this by sliding downward along the outside of the top housing 22.

Those skilled in the art will appreciate that the sealing member 26 may be configured in a variety of ways to cover and close the openings 42, 43. For example, the sealing member 26 may be configured to slide upward along the outside of the top housing 22.

The sample cup 28 holds the sample 30 being analyzed and prevents the sample material from contacting the housings 22, 24. The sample cup 28 can be reused multiple times, or it can be disposed after each use. In general, the sample cup 28 can be disposed of after each use to minimize the possibility of contamination from one sample to the next.

The sample container 18 also includes a temperature sensor 52 located at the top of the sample chamber 40. The temperature sensor 52 is connected to the electronics 32 and extends through the top wall of the top housing 22. The temperature sensor 52 is positioned at the top of the sample chamber 40 to allow it to directly measure the temperature of the sample 30.

Those skilled in the art will appreciate that the temperature sensor 52 may be any suitable temperature sensor. In one embodiment, the temperature sensor 52 includes an infrared temperature sensor or infrared thermometer that measures a portion of the infrared thermal radiation (i.e., blackbody radiation) emitted by the sample 30 and uses that to determine the sample's temperature. The infrared temperature sensor may include a lens that focuses the infrared thermal radiation on a detector, which converts the radiant power to an electrical signal that is transmitted to the electronics 32. A suitable temperature sensor is GE ZTP-315 sensor.

The electronics 32 may include a variety of electrical hardware and/or software. In one embodiment, the electronics include a processor, memory, and a wireless or wired communication component. The electronics 32 may be used to allow the sample container 18 to process, store, transmit, and/or receive data regarding the sample 30.

For example, the electronics 32 may be configured to receive an electrical signal from the temperature sensor 52, convert it into a temperature reading, and transmit the temperature to a remote computer where the temperature is used to calculate the water activity of the sample. In another embodiment, the electronics 32 may receive information regarding the concentration of water vapor in the sample and use the processor to calculate the water activity. The measured water activity is stored in the electronics 32 until needed later.

The sample container 18 and any of its subcomponents may be made of any suitable material. Examples of suitable materials include metals, plastics, and composites. In one embodiment, the housings 22, 24 and/or the sealing member 26 may be made of aluminum. Aluminum may be desirable because it is easy to machine, has high thermal conductivity (allows the sample 30 to equilibrate with the environment faster), and it can be coated with a coating or anodized to seal any pores.

Referring back to FIG. 1, the feeding assembly 14 includes a magazine 56 that holds a vertical stack of sample containers 18. The sample containers 18 move downward through the magazine 56 as each sample container 18 is taken from the bottom of the stack and analyzed. The residence time of the sample containers 18 in the stack allows the samples 30 to equilibrate at measurement temperature.

The feeding assembly 14 also includes an actuator 58 that moves the sample containers 18 from the magazine 56 to the measurement station 20. In one embodiment, the actuator 58 is a linear actuator that pushes the bottom sample container 18 to the measurement station 20.

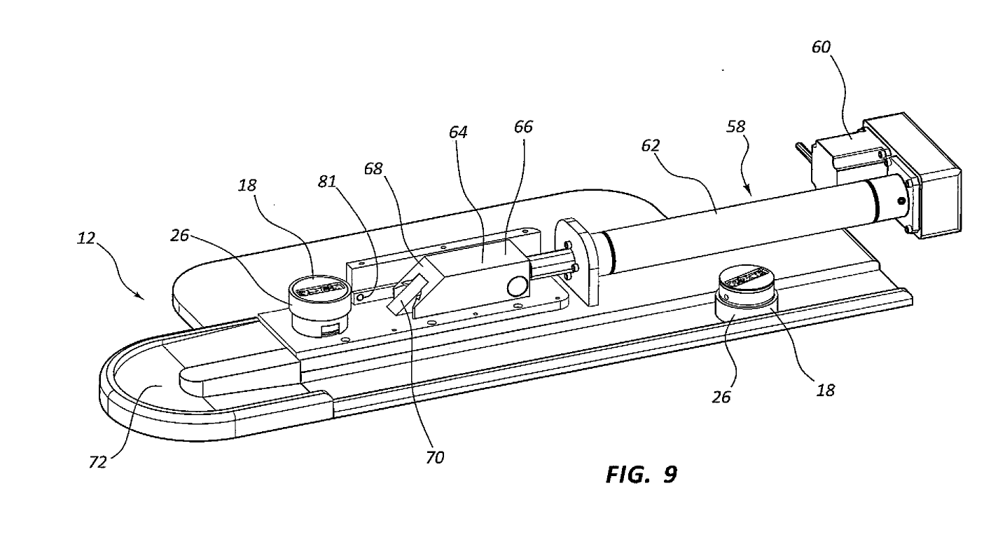

FIG. 9 shows the actuator 58 in greater detail. The actuator 58 includes a motor 60 that extends and retracts a drive cylinder 62 to move the sample container 18. A drive block 64 is positioned at the distal end of the drive cylinder 62. The drive block 64 moves between a retracted position where the drive block 64 is not in contact with the sample containers 18 to an extended position where drive block 64 pushes a sample container 18 to the measurement station 20.

The drive block 64 is elongated so that as it moves to the extended position, the top surface 66 of the drive block 64 holds the sample containers 18 in the magazine 56 in place. The drive block 64 also has a sloped face 68 so that as it moves from the extended position to the retracted position, the drive block 64 allows the next sample container 18 to slowly lower into position.

The sloped face 68 of the drive block 64 includes a wedge member 70 that is configured to continue the slope of face 68 thereby lowering the sample container 18 to its lowest position. Wedge member 70 retracts as the sample container 18 is pushed forward. Notch 54 in the sample container 18 aligns properly as the sample container 18 passes spring ball 81 while it moves to the measurement station 20. The openings 42, 43 should be in a certain position to facilitate measurement of the water activity of the sample 30 when the sample container 18 is at the measurement station 20.

The actuator 58 and drive block 64 may be configured in a variety of different ways from that shown in the Figs. Any of a variety of components and methods may be used to move the sample container 18 to the measurement station 20.

The base 12 includes a downward sloping ramp 72 that receives the sample container 18 after it has been analyzed at the measurement station 20. The spent sample container 18 is pushed down the ramp 72 by the next sample container 18 as it is pushed to the measurement station 20 by the actuator 58. A spent sample container 18 is shown on the far end of the ramp 72 in FIGS. 1, 7, and 9.

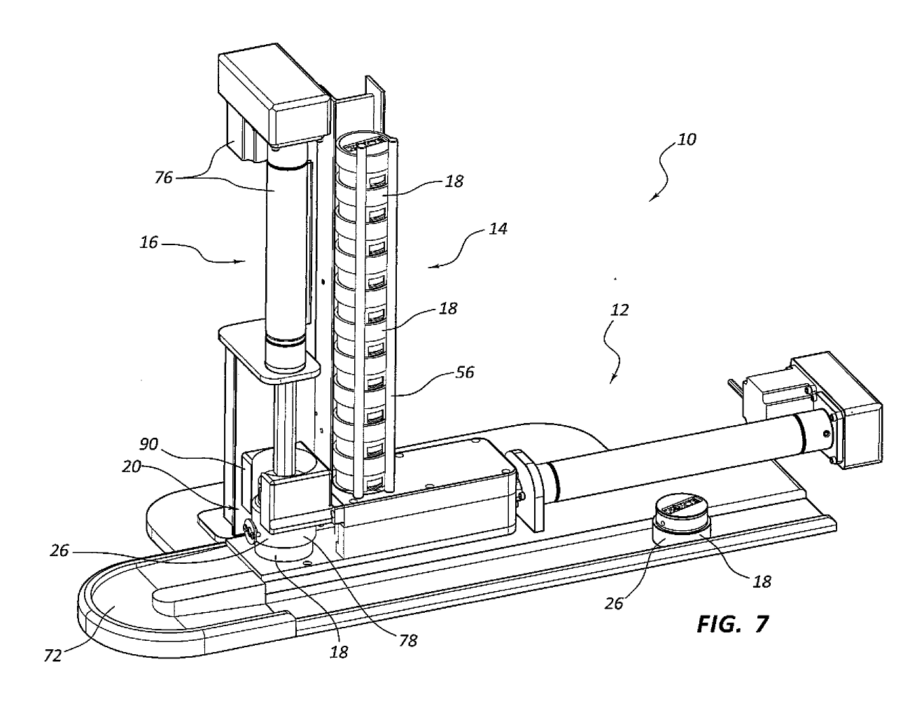

The sensor assembly 16 includes an actuator 76 coupled to a sensor unit 78. The actuator 76 moves the sensor unit 78 toward and away from the measurement station 20. FIG. 1 shows the sensor unit 78 in the retracted or raised position away from the sample container 18. FIG. 7 shows the sensor unit 78 in the extended or lowered position adjacent to the sample container 18 and ready to take the measurement.

FIG. 8 shows the sensor unit 78 positioned over the sample container 18. The sensor unit 78 includes a housing 80 that slides along the outside surface of the top housing 22 of the sample container 18. The housing 80 pushes the sealing member 26 downward away from the openings 42, 43. The housing 80 and the sealing member 26 fit closely together so that as the sealing member 26 moves downward, the housing 80 immediately covers the openings 42, 43. In this way, the gases in the sample chamber 40 are not exposed to or contaminated with outside air.

The sensor unit 78 is surrounded by a heat sink 90 when the sensor unit 78 is in the extended position. The heat sink 90 helps to maintain the temperature of the sensor unit 78 and the sample container 18 constant during the measurement process.

It should be appreciated that the sensor unit 78 and its housing 80 can have any suitable configuration as long as the sensor unit 78 is capable of moving the sealing member 26 to provide access to the openings 42, 43. In one embodiment, a seal can be provided between the housing 80 and the sealing member 26 to further prevent outside air from entering the sample chamber 40.

The sensor unit 78 includes openings or holes 82, 83 that align with the openings 42, 43, respectively, in the sample container 18. The tunable diode laser 74 emits laser radiation through the openings 42, 43, 82 and into the interior of the sample chamber 40 where it passes through the gaseous mixture in the head space of the sample container 18.

The tunable diode laser 74 includes a laser radiation source 84 that emits the laser radiation and a laser radiation detector 86 that receives the emitted laser radiation. The concentration of a gas species in the sample chamber 40, as well as other parameters, may be measured by comparing the emitted laser radiation to the detected laser radiation. The tunable diode laser 74 may also include other components such as optics to facilitate transmission and detection of the laser radiation.

Any suitable tunable diode laser 74 may be used. For example, the laser radiation may be generated by a temperature controlled diode and transmitted through a fiber optic cable to the interior of the sample chamber 40. Examples of suitable tunable diode lasers may be found in U.S. Pat. Nos. 6,639,678, 7,616,316, 7,230,711, 7,126,685, 7,092,852, 7,003,436, 6,940,599, 6,615,142, all of which are incorporated herein by this reference in their entireties.

The laser radiation source 84 may be positioned on one side of the sample container 18 and the laser radiation detector 86 may be positioned on the opposite side of the sample container 18. For example, the laser radiation source 84 may be positioned to emit laser radiation through the openings 42, 82, and the laser radiation detector 86 may be positioned to receive the laser radiation through openings 43, 83.

In one embodiment, the laser radiation source 84 and the laser radiation detector 86 are coupled to and part of the sensor unit 78. For example, the laser radiation source 84 and the laser radiation detector 86 can be coupled to the side of the housing 80 over the openings 82, 83. In another embodiment, the laser radiation source 84 and the laser radiation detector 86 are separate from the sensor unit 78.

The measurement apparatus 10 may be operated in the following manner. The sample 30 is positioned in the sample cup 28 and put into the sample container 18. The sample 30 is allowed to equilibrate inside the sample chamber 40 at control temperature. This may happen while the sample container 18 is in the magazine 56 or at some other location. Once the sample 30 has reached equilibrium, the amount of water vapor in the sample chamber 40 should reflect the activity of the water in the sample 30. The sample container 18 is sealed during the equilibration process.

Information about each sample 30 may be added to the electronics 32. This may be done manually or wirelessly. When the sample 30 is evaluated, the data generated is added to the electronics 32 or to a main processor for the apparatus.

The actuator moves the sample container 18 to the measurement station 20 where it is ready to be analyzed with the sensor unit 78. The actuator 76 moves the sensor unit 78 downward over the sample container 18. The housing 80 of the sensor unit 78 contacts the sealing member 26 and pushes it downward until the openings 82, 83 in the housing 80 are aligned with the openings 42, 43, respectively, in the top housing 22. During this process, the sample chamber 40 remains sealed from outside air.

At this position, the tunable diode laser 74 is aligned with the openings 42, 43, 82, 83. The tunable diode laser 74 emits laser radiation through the gaseous mixture in the head space of the sample chamber 40. At the same time, the temperature of the sample 30 is measured with the temperature sensor 52. The raw data obtained are then processed to calculate the water activity of the sample 30.

After the measurement has been made, the sensor unit 78 is raised and the sample container 18 is pushed on to the ramp 72 by the next sample container 18. The sealing member 26 remains in the lowered position because once the measurement has been made it no longer matters if outside air enters the sample chamber 40.

### Illustrative Embodiments

Reference is made in the following to a number of illustrative embodiments of the disclosed subject matter. The following embodiments illustrate only a few selected embodiments that may include one or more of the various features, characteristics, and advantages of the disclosed subject matter. Accordingly, the following embodiments should not be considered as being comprehensive of all of the possible embodiments.

The concepts and aspects of one embodiment may apply equally to one or more other embodiments or may be used in combination with any of the concepts and aspects from the other embodiments. Any combination of any of the disclosed subject matter is contemplated.

In one embodiment, a measurement apparatus comprises: a sample chamber enclosing a gaseous mixture and a tunable diode laser configured to emit laser radiation through the gaseous mixture in the sample chamber without passing through a wall of the sample chamber. The sample chamber may be sealed from the air or atmosphere outside the sample chamber.

The tunable diode laser may be configured to emit the laser radiation through the gaseous mixture in the sample chamber without passing through the air outside the sample chamber. The tunable diode laser may include a laser radiation source and a laser radiation detector. The laser radiation may be emitted from the laser radiation source and received by the laser radiation detector without passing through a wall of the sample chamber.

The measurement apparatus may include a laser radiation source and a laser radiation detector. The laser radiation is emitted from the laser radiation source and received by the laser radiation detector without passing through the air outside the sample chamber. The laser radiation source and the laser radiation detector may both be in fluid communication with the gaseous mixture in the sample chamber.

The measurement apparatus may comprise a sample container that includes the sample chamber. The tunable diode laser may include a laser radiation source and a laser radiation detector both of which are separate from the sample container. The laser radiation source and the laser radiation detector may be exposed to the gaseous mixture in the sample chamber.

The measurement apparatus may comprise a sample container including a sealing member that moves between a closed position where the sealing member covers an opening into the sample chamber and an open position where the sealing member does not cover the opening into the sample chamber. The measurement apparatus may move the sealing member from the closed position to the open position while keeping the sample chamber sealed from the air outside the sample chamber.

The measurement may comprise a magazine configured to hold multiple sample containers each of which includes a sample chamber enclosing a gaseous mixture. The measurement apparatus may also comprise a plurality of sample containers positioned in the magazine, each of which includes a sealed sample chamber enclosing a gaseous mixture. The measurement apparatus may be configured to successively move, without operator input, the plurality of sample containers to a measurement station where the tunable diode laser emits the laser radiation through the gaseous mixture without passing through a wall of the sample chamber.

The measurement apparatus may be configured to measure the water activity of a sample in the sample chamber. The measurement apparatus may comprise a temperature sensor configured to measure the temperature of a sample in the sample chamber.

In another embodiment, the measurement apparatus comprises: a sample chamber enclosing a gaseous mixture, a tunable diode laser configured to emit laser radiation through the gaseous mixture in the sample chamber, and a temperature sensor configured to measure the temperature of a sample in the sample chamber. The sample chamber is sealed from the air outside the sample chamber.

The temperature sensor may be positioned inside the sample chamber and/or at the top of the sample chamber. The temperature sensor may be an infrared temperature sensor.

The tunable diode laser may be configured to emit the laser radiation through the gaseous mixture in the sample chamber without passing through the air outside the sample chamber. The tunable diode laser may include a laser radiation source and a laser radiation detector. The laser radiation is emitted from the laser radiation source and received by the laser radiation detector without passing through a wall of the sample chamber.

The measurement apparatus may comprise a sample container including a sealing member that moves between a closed position where the sealing member covers an opening into the sample chamber and an open position where the sealing member does not cover the opening into the sample chamber. The measurement apparatus may move the sealing member from the closed position to the open position while keeping the sample chamber sealed from the air outside the sample chamber.

The measurement apparatus may comprise a plurality of sample containers each of which includes a sealed sample chamber enclosing a gaseous mixture. The measurement apparatus may be configured to successively move, without operator input, the plurality of sample containers to a measurement station where the tunable diode laser emits the laser radiation through the gaseous mixture without passing through a wall of the sample chamber.

The measurement apparatus may be configured to measure the water activity of a sample in the sample chamber.

In another embodiment, a sample container comprises: a sample chamber enclosing a gaseous mixture and a sealing member that moves between a closed position where the sealing member covers an opening into the sample chamber and an open position where the sealing member does not cover the opening into the sample chamber. The sample chamber is sealed from the air outside the sample chamber. The sample chamber may be configured to cooperate with a tunable diode laser measurement apparatus that moves the sealing member from the closed position to the open position while keeping the sample chamber sealed from the air outside the sample chamber.

The sample container may comprise a temperature sensor configured to measure the temperature of a sample of non-gaseous material in the sample chamber. The temperature sensor may be positioned at the top of the sample chamber. The temperature sensor may be an infrared temperature sensor. The temperature sensor may be positioned inside the sample chamber.

The opening may be a first opening and the sample container may comprise a second opening into the sample chamber positioned opposite the first opening. The sample container may comprise one or more sealing members that move between a closed position where the one or more sealing members cover the first opening and the second opening and an open position where the one or more sealing members do not cover the first opening and the second opening.

The sample container may comprise a housing component having a cylindrical shape and forming at least part of the sample chamber. The sealing member may include a sealing ring that slides along the housing component to move the sealing member between the closed position and the open position. The sample container may comprise a top housing open at the bottom and a bottom housing open at the top. The top housing and the bottom housing fit together to form the sample chamber and enclose the gaseous mixture.

The sample container may comprise a sample cup positioned in the bottom housing. The sample cup is separable from the top housing and the bottom housing and configured to hold a sample of non-gaseous material.

The sample container may comprise electronics that store, transmit, and/or receive information about a sample of non-aqueous material in the sample container.

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure the term shall mean,” etc.).

References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope.

The subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be given their broadest interpretation in view of the prior art and the meaning of the claim terms.

As used herein, spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

All ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A measurement apparatus comprising:
a sample chamber enclosing a gaseous mixture, the sample chamber being sealed from the air outside the sample chamber; and
a tunable diode laser configured to emit laser radiation through the gaseous mixture in the sample chamber without passing through a wall of the sample chamber.

2. The measurement apparatus of claim 1 wherein the tunable diode laser is configured to emit the laser radiation through the gaseous mixture in the sample chamber without passing through the air outside the sample chamber.

3. The measurement apparatus of claim 1 wherein the tunable diode laser includes a laser radiation source and a laser radiation detector, and wherein the laser radiation is emitted from the laser radiation source and received by the laser radiation detector without passing through a wall of the sample chamber.

4. The measurement apparatus of claim 1 comprising a sample container including a sealing member that moves between a closed position where the sealing member covers an opening into the sample chamber and an open position where the sealing member does not cover the opening into the sample chamber.

5. The measurement apparatus of claim 4 wherein the measurement apparatus moves the sealing member from the closed position to the open position while keeping the sample chamber sealed from the air outside the sample chamber.

6. The measurement apparatus of claim 1 comprising a plurality of sample containers each of which includes a sealed sample chamber enclosing a gaseous mixture, wherein the measurement apparatus is configured to successively move, without operator input, the plurality of sample containers to a measurement station where the tunable diode laser emits the laser radiation through the gaseous mixture without passing through a wall of the sample chamber.

7. The measurement apparatus of claim 1 wherein the measurement apparatus is configured to measure the water activity of a sample in the sample chamber.

8. The measurement apparatus of claim 1 comprising a temperature sensor configured to measure the temperature of a sample in the sample chamber.

9. A measurement apparatus comprising:
a sample chamber enclosing a gaseous mixture, the sample chamber being sealed from the air outside the sample chamber;
a tunable diode laser configured to emit laser radiation through the gaseous mixture in the sample chamber; and
a temperature sensor configured to measure the temperature of a sample in the sample chamber.

10. The measurement apparatus of claim 9 wherein the temperature sensor is an infrared temperature sensor.

11. The measurement apparatus of claim 9 wherein the temperature sensor is positioned at the top of the sample chamber.

12. The measurement apparatus of claim 9 wherein the tunable diode laser is configured to emit the laser radiation through the gaseous mixture in the sample chamber without passing through the air outside the sample chamber.

13. The measurement apparatus of claim 9 wherein the tunable diode laser includes a laser radiation source and a laser radiation detector, and wherein the laser radiation is emitted from the laser radiation source and received by the laser radiation detector without passing through a wall of the sample chamber.

14. The measurement apparatus of claim 9 comprising a sample container including a sealing member that moves between a closed position where the sealing member covers an opening into the sample chamber and an open position where the sealing member does not cover the opening into the sample chamber.

15. The measurement apparatus of claim 14 wherein the measurement apparatus moves the sealing member from the closed position to the open position while keeping the sample chamber sealed from the air outside the sample chamber.

16. The measurement apparatus of claim 9 comprising a plurality of sample containers each of which includes a sealed sample chamber enclosing a gaseous mixture, wherein the measurement apparatus is configured to successively move, without operator input, the plurality of sample containers to a measurement station where the tunable diode laser emits the laser radiation through the gaseous mixture without passing through a wall of the sample chamber.

17. The measurement apparatus of claim 9 wherein the measurement apparatus is configured to measure the water activity of a sample in the sample chamber.

18. A sample container comprising:
a sample chamber enclosing a gaseous mixture, the sample chamber being sealed from the air outside the sample chamber; and
a sealing member that moves between a closed position where the sealing member covers an opening into the sample chamber and an open position where the sealing member does not cover the opening into the sample chamber;
wherein the sample chamber is configured to cooperate with a tunable diode laser measurement apparatus that moves the sealing member from the closed position to the open position while keeping the sample chamber sealed from the air outside the sample chamber.

19. The sample container of claim 18 comprising a temperature sensor configured to measure the temperature of a sample of non-gaseous material in the sample chamber.

20. The sample container of claim 19 wherein the temperature sensor is positioned at the top of the sample chamber.

21. The sample container of claim 19 wherein the temperature sensor is an infrared temperature sensor.

22. The sample container of claim 18 wherein the opening is a first opening and the sample container comprises a second opening into the sample chamber positioned opposite the first opening.

23. The sample container of claim 22 comprising one or more sealing members that move between a closed position where the one or more sealing members cover the first opening and the second opening and an open position where the one or more sealing members do not cover the first opening and the second opening.

24. The sample container of claim 18 comprising a housing component having a cylindrical shape and forming at least part of the sample chamber, wherein the sealing member includes a sealing ring that slides along the housing component to move the sealing member between the closed position and the open position.

25. The sample container of claim 18 comprising a top housing open at the bottom and a bottom housing open at the top, wherein the top housing and the bottom housing fit together to form the sample chamber and enclose the gaseous mixture.

26. The sample container of claim 25 comprising a sample cup positioned in the bottom housing, the sample cup being separable from the top housing and the bottom housing and configured to hold a sample of non-gaseous material.

27. The sample container of claim 18 comprising electronics that store, transmit, and/or receive information about a sample of non-gaseous material in the sample container.
